(19) United States
(12) Patent Application Publication
(10) Pub. No.: US 2022/0071218 A1
(43) Pub. Date: Mar. 10, 2022

(54) FLEXIBLE CONTAINER

(71) Applicant: YANGJIANG EKA INDUSTRAIAL LTD., Guangdong (CN)

(72) Inventors: Geng SU, Guangdong (CN); Yue LIN, Guangdong (CN); Wei CAI, Guangdong (CN)

(73) Assignee: YANGJIANG EKA INDUSTRAIAL LTD., Guangdong (CN)

(21) Appl. No.: 17/238,209

(22) Filed: Apr. 23, 2021

(30) Foreign Application Priority Data
Sep. 4, 2020 (CN) 202021920599.8

(51) Int. Cl. A21B 3/13; B65D 1/36; B65D 1/46

(52) U.S. Cl. CPC A21B 3/138; B65D 1/46; B65D 1/36; A21B 3/136

(57) ABSTRACT

A flexible container includes a tray made of silica gel. The tray is integrally formed with at least one placement cavity with an opening at its top portion. A peripheral flange extends outward from a peripheral edge of the tray. The peripheral flange continuously surrounds the peripheral edge of the tray, and the peripheral flange is embedded with a reinforcing ring. A cross-section of the reinforcing ring has a longitudinal length greater than a lateral length. The invention adopts the reinforcing ring with its cross-section having the longitudinal length greater than the lateral length as a frame reinforcing element, and the reinforcing ring is embedded in the peripheral flange extending outwardly from the edge of the tray.

### CROSS-REFERENCE TO RELATED APPLICATION

This application claims the priority benefit of China application serial no. 202021920599.8, filed on Sep. 4, 2020. The entirety of the above-mentioned patent application is hereby incorporated by reference herein and made a part of this specification.

### BACKGROUND

### Technical Field

The invention relates to a technical field of a container, and more particularly, to a flexible container.

### Description of Related Art

As a molding container for food processing, a silica gel mold is commonly used for making cakes, breads, jelly, prepared foods, ice cubes, and as food preservation, etc., as its characteristics such as environmental protection, high temperature resistance, wide applicable temperature, softness and comfort, etc., it is a common tool for the food processing.

However, due to a relatively soft texture of silica gel, it is generally necessary to add a reinforcing element inside it to increase its strength and adapt to daily use. An outer edge of a conventional silica gel container is generally embedded with a metal reinforcing ring. Although the reinforcement ring enhances strength of the edge of the mold, it still has a problem of easy torsion, especially for some large-size cake molds with only one placement cavity. If the mold is pressed with a long side as a center, deformation is more likely to occur, and there is a problem of insufficient torsion resistance in actual use. For example, in the case of a cake baking, a silica gel cake mold in which an iron frame is embedded in the edge of the container, during a baking process, especially during baking completion, the outer edge of the food mold needs to be pressed in order to release the food from the food mold, and repeated pressing in the vertical direction may twist the iron frame embedded in the outer edge, thereby causing the deformation of the food mold to affect the use. At the same time, the silica gel container applied to other aspects has the above-mentioned problem of easy torsion.

### SUMMARY

In order to overcome the defects that the silica gel mold described in the prior art is easy to twist and deform in the vertical direction, the invention provides a flexible container, which adopts a reinforcing ring with stronger torsion resistance, effectively avoids torsion and deformation in a vertical direction, and improves stability of a product structure.

To solve the above technical problems, the invention adopts following technical solutions.

A flexible container includes a tray made of silica gel. The tray is integrally formed with at least one placement cavity with an opening at its top portion. A peripheral flange extends outward from a peripheral edge of the tray. The peripheral flange continuously surrounds the peripheral edge of the tray, and the peripheral flange is embedded with a reinforcing ring. A cross-section of the reinforcing ring has a longitudinal length greater than a lateral length.

In the above-mentioned solution, the placement cavity is used for food molding, which is similar to a conventional baking tray structure. The tray and the placement cavity are integrally formed, and the reinforcing ring is completely embedded in the peripheral flange, thereby improving strength of the container frame. At the same time, the cross-section of the reinforcing ring has the longitudinal length greater than the lateral length, so that the reinforcing ring has better torsion resistance in the vertical direction. The use of the reinforcing ring increases a thickness of the container frame in the vertical direction and effectively reduces the torsion in the vertical direction, particularly for a large-sized food container having one placement cavity, a size of the frame is large and an iron frame is more easily twisted due to an increase in torque. Since the thickness of the reinforcing ring in the vertical direction is increased, a pressure exerted by the torsion of the reinforcing ring in the vertical direction is increased, the torsion resistance of the food container is enhanced, and the stability of the food container can be effectively improved.

Further, the reinforcing ring has a rectangular cross-section with better torsion resistance in the vertical direction.

Further, horizontal projections of side surfaces of the reinforcing ring and side surfaces between upper and lower surfaces of the tray at least partially overlap. Since flexible materials such as the silica gel have the characteristic of natural shrinkage, a central portion of the tray drives a peripheral portion, especially an edge portion, to shrink, which causes an overall structure of the container to be deformed. The horizontal projections of the side surfaces of the reinforcing ring and the side surfaces between upper and lower surfaces of the tray at least partially overlap, thereby enhancing a rigidity of the edge portion, so that the reinforcing ring has a good traction effect on the edge of the tray and resists the deformation of the edge portion due to the shrinkage of the central portion of the tray, and facilitating the overall stability of the container structure.

Further, a top surface of the reinforcing ring is higher than the upper surface of the tray, and a bottom surface of the reinforcing ring is lower than the lower surface of the tray, that is, the reinforcing ring integrally has a maximum support across the upper and lower surfaces of the tray. A distance between the top surface of the reinforcing ring and the upper surface of the tray is equal to a distance between the bottom surface of the reinforcing ring and the lower surface of the tray, that is, the traction effect of the reinforcing ring on upper and lower sides of the tray is equal, and the stability of the structure is optimal.

Of course, the top surface of the reinforcing ring is lower than the upper surface of the tray and higher than the lower surface of the tray. The bottom surface of the reinforcing ring is lower than the lower surface of the tray. In this solution, a higher flange is provided below the edge of the tray to enhance a grip. Alternatively, the top surface of the reinforcing ring is higher than the upper surface of the tray. The bottom surface of the reinforcing ring is lower than the upper surface of the tray and higher than the lower surface of the tray. In this solution, a bottom surface of the peripheral flange is flush with the lower surface of the tray, and the higher flange is provided above the edge of the tray, which can be applied to baking tray products and not only increases the torsion resistance of the baking tray, but also prevents liquid from overflowing.

Further, the bottom surface of the peripheral flange is lower than the lower surface of the tray, and the peripheral flange is spaced at a distance from the placement cavity so that the tray is formed with a gripping surface portion between the peripheral flange and the placement cavity. The gripping surface portion forms a gripping area for fingers, thereby facilitating gripping transfer, and the peripheral flange functions as an anti-skid function.

Further, a number of the placement cavity is even, each placement cavity is distributed in an array, the tray is in a rectangular structure, and a width of the gripping surface portion of one of opposite sides of the tray is smaller than a width of the gripping surface portion of the other one of the opposite sides. A larger width of the gripping surface portion serves as the gripping area for a preferred gripping area for fingers, and the placement cavity can obtain a higher setting space on the tray.

Further, a protruding rib extends upwardly from an edge of the opening of the placement cavity of the tray, and the protruding rib continuously surrounds the opening of the placement cavity and is integrally formed with the tray. Due to the material characteristics of the silica gel, a thicker portion generates a large internal tensile force, which will cause the traction effect on a thinner portion. The protruding rib is the thicker portion to a plane near the opening of the placement cavity and a flexible wall of the placement cavity, and generates a certain upward tensile force to the plane near the opening of the placement cavity and the flexible wall of the placement cavity, thereby avoiding the deformation of the placement cavity due to the tensile force in other directions, and facilitating the stability of the structure of the opening of the placement cavity and the flexible wall of the placement cavity.

Further, since a plurality of containers generally need to be stacked together during transport or storage, in order to avoid wear of the protruding rib, a protrusion height of the peripheral flange is greater than a protrusion height of the protruding rib.

Further, the tray is formed by injection molding, which simplifies the process.

Compared with the prior art, the invention adopts the reinforcing ring with its cross-section has the longitudinal length greater than the lateral length as a frame reinforcing element, and the reinforcing ring is embedded in the peripheral flange extending outwardly from the edge of the tray, so that the strength of the peripheral flange is increased, the torsion resistance of the peripheral flange in the vertical direction is effectively improved, and the stability of the product structure is effectively improved.

### BRIEF DESCRIPTION OF THE DRAWINGS

FIG. 1 is a schematic diagram of an overall structure of a flexible container according to Embodiment 1 of the invention.

FIG. 2 is a cross-sectional view of an overall structure of the flexible container according to Embodiment 1 of the invention.

FIG. 3 is a structural diagram of a reinforcing ring according to Embodiment 1 of the invention.

FIG. 4 is a sectional view of an edge portion of the flexible container according to Embodiment 1 of the invention.

FIG. 5 is a sectional view of an edge portion of a flexible container according to Embodiment 2 of the invention.

FIG. 6 is a sectional view of an edge portion of a flexible container according to Embodiment 3 of the invention.

### DESCRIPTION OF THE EMBODIMENTS

Drawings are for illustrative purposes only and are not to be construed as limiting the patent. In order to better illustrate these embodiments, certain parts of the drawings may be omitted, enlarged or reduced, and do not represent dimensions of an actual product. It will be appreciated by those skilled in the art that certain well-known structures in the drawings and descriptions thereof may be omitted. A positional relationship described in the drawings is for illustrative purposes only and is not to be construed as limiting the patent.

The same or similar reference numerals in the drawings of the embodiments of the invention correspond to the same or similar parts. In the description of the invention, it should be understood that if there are the terms “upper”, “lower”, “left”, “right”, “long”, “short”, etc., the orientation or positional relationship indicated is based on the drawings. The orientation or positional relationship of is only for the convenience of describing the invention and simplifying the description, it does not indicate or imply that the device or element referred to must have a specific orientation, be constructed and operated in a specific orientation. Therefore, the terms describing the positional relationship in the drawings are only for illustrative purposes and cannot be understood as a limitation of the patent. Those of ordinary skill in the art can understand the specific meanings of the above-mentioned terms according to specific situations.

In the following, the technical solutions of the invention will be further described in detail through specific embodiments in conjunction with the accompanying drawings.

### Embodiment 1

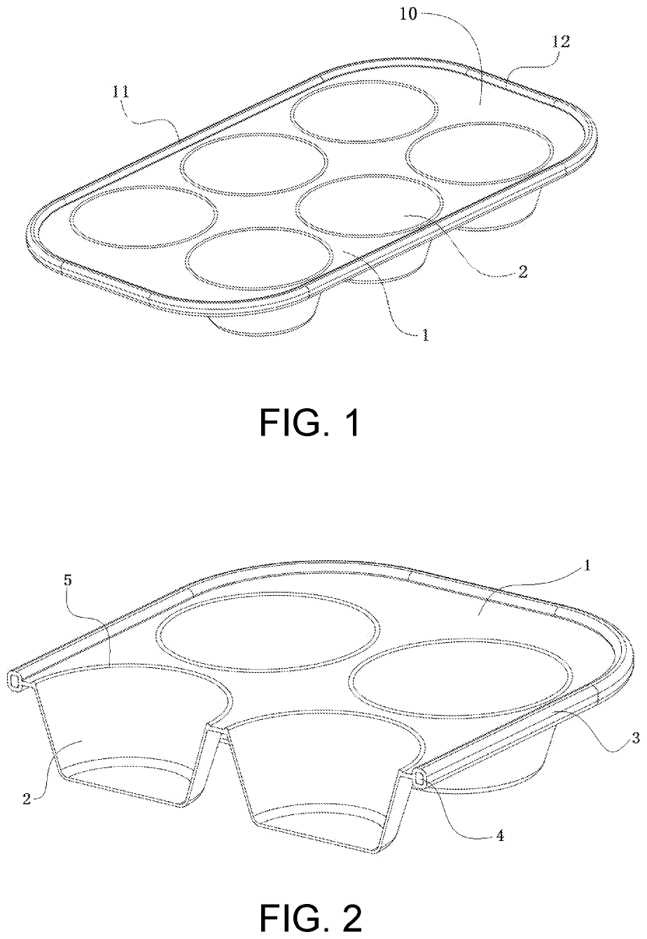

As shown in FIG. 1 and FIG. 2, this embodiment provides a flexible container including a tray 1, wherein the tray 1 is in a rectangular structure. The tray 1 is provided with six placement cavities 2 for food molding. Each placement cavity 2 is distributed in an array and has a top portion formed with an opening. At the same time, the tray 1 and the placement cavity 2 are made of silica gel, and the two are integrated by injection molding.

Specifically, an edge of the rectangular tray 1 includes opposite long sides 11 on both sides and short sides 12 on both sides, and the long sides 11 and the short sides 12 are in contact with each other by a fillet transition. In this embodiment, the position between the corresponding long sides 11 of the tray 1 and an edge of the placement cavity 2 forms a lateral gripping surface portion 10. The position between the corresponding short sides 12 and the edge of the placement cavity 2 of the tray 1 forms a longitudinal gripping surface portion 10. A width of the lateral gripping surface portion 10 is smaller than a width of the longitudinal gripping surface portion 10, that is, the longitudinal gripping surface portion 10 on an opposite side of the tray 1 forms a larger transition plane as a gripping area, which is convenient for users to grip the area with fingers to transfer the container.

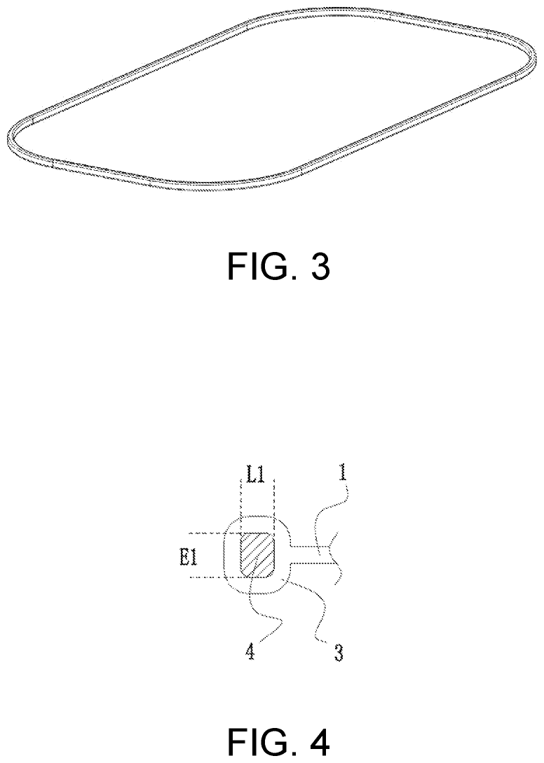

Further, a peripheral flange 3 extends outwardly from a peripheral edge of the tray 1, and the peripheral flange 3 continuously surrounds the peripheral edge of the tray 1, and a reinforcing ring 4 made of metal is embedded in the peripheral flange 3, and the reinforcing ring 4 is disposed around the edge of the tray 1. Specifically, as shown in FIG. 3 and FIG. 4, the reinforcing ring 4 is an annular vertical iron. A cross-section of the reinforcing ring 4 is rectangular. The cross-section of the reinforcing ring 4 has a longitudinal length E1 and a lateral length L1, wherein E1 is greater than L1. A use of the reinforcing ring 4 increases a thickness of the container frame in a vertical direction and effectively reduces torsion in the vertical direction. Especially for a large-size food container with one placement cavity 2, a frame size is relatively large. Due to an increase in torque, it is easier to twist an iron frame. Since the thickness of the reinforcing ring 4 in the vertical direction is increased, a pressure exerted by the torsion of the reinforcing ring 4 in the vertical direction is increased, a torsion resistance of the food container is enhanced, and a stability of the food container can be effectively improved.

At the same time, a top surface of the reinforcing ring 4 is higher than an upper surface of the tray 1, and a bottom surface of the reinforcing ring 4 is lower than a lower surface of the tray 1. Preferably, a distance between the top surface of the reinforcing ring 4 and the upper surface of the tray 1 is equal to a distance between the bottom surface of the reinforcing ring 4 and the lower surface of the tray 1. The reinforcing ring 4 is embedded in the peripheral flange 3 at the edge of the tray 1, so that a strength of the peripheral flange 3 is increased, and at the same time, a traction effect of the reinforcing ring to upper and lower sides of the tray is equal, while the strength and stability of the container are satisfied. At the same time, the peripheral flange 3 protrudes with respect to the upper and lower surfaces of the tray 1. A lower portion of the peripheral flange 3 and the gripping surface portion 10 forms an approximately “inverted L” type gripping area. Through the formed “inverted L” type gripping area, fingers can firmly grip the gripping surface portion 10 of the tray 1 during transportation, and increase a contact area with the tray 1. The lower portion of the peripheral flange 3 also functions as an anti-skid function, thereby avoiding the fingers from slipping off the edge of the tray 1, thereby greatly enhancing the stability of the grip. Since the tray 1 of the silica gel container is made of silica gel, the tray 1 has a tendency to shrink inward, and each of the placement cavities 2 of the tray 1 has a large weight, which also makes a main body portion as a whole have a tendency to sink. Therefore, by embedding the reinforcing ring 4 in the peripheral flange 3 horizontally connected with the tray 1, strength of the outer edge portion horizontally connected with the tray 1 is increased. When the placement cavity 2 sinks and the plane of the tray 1 shrinks inward, the peripheral flange 3 provides sufficient strength to resist the sinking and shrinkage of the main body, and maintain the structural stability of the flexible container.

This embodiment uses the annular vertical iron to solve the problem of insufficient torsion resistance of the existing cake mold. The reinforcing ring 4 is embedded in the peripheral flange 3, and a height of the top surface of the reinforcing ring 4 is higher than that of the upper surface of the plane of the tray 1, and a height of the bottom surface of the reinforcing ring 4 is lower than that of the lower surface of the plane of the tray 1. In this way, the strength of the peripheral flange 3 connected to the plane of the tray 1 is increased, so that the supporting force for preventing the main body of the placement cavity 2 in the tray 1 from shrinking and sinking can be provided, and the structure of the container is kept stable. At the same time, the lower portion of the peripheral flange 3 and the gripping surface portion 10 form the “inverted L” type, forming the gripping area for convenient use.

Further, a protruding rib 5 extends upwardly from an edge of the opening of the placement cavity of the tray, and the protruding rib 5 continuously surrounds the opening portion of the placement cavity 2 and is integrally formed with the placement cavity 2. Due to the material characteristics of the silica gel, a thicker portion generates a large internal tensile force, which will cause traction effect on a thinner portion. The protruding rib 5 is the thicker portion to a plane near the opening of the placement cavity 2 and a flexible wall of the placement cavity 2, and generates a certain upward tensile force to the plane near the opening of the placement cavity 2 and the flexible wall of the placement cavity 2, thereby avoiding deformation of the placement cavity 2 due to the tensile force in other directions, and facilitating stability of the structure of the opening of the placement cavity 2 and the flexible wall of the placement cavity 2.

It is worth noting that a protrusion height of the peripheral flange 3 is greater than a protrusion height of the protruding rib 5, which prevents the protruding rib 5 from being worn during a stacking process of multiple containers.

### Embodiment 2

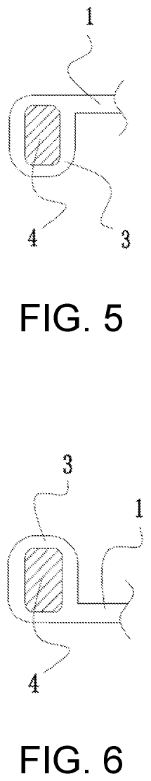

As shown in FIG. 5, this embodiment also provides a flexible container having a structure similar to that of Embodiment 1, except that a top surface of a reinforcing ring 4 in this embodiment is lower than an upper surface of a tray 1 and higher than a lower surface of the tray 1. A bottom surface of the reinforcing ring 4 is lower than the lower surface of the tray 1. This embodiment is also a particular way of arranging the reinforcing ring 4 in such a position that the reinforcing ring 4 is embedded in a peripheral flange 3 so that a rigidity and a stability of the peripheral flange as a whole are enhanced, the tray 1 is provided with sufficient support to avoid shrinkage and sinking, and a top surface of the peripheral flange 3 is equal to or slightly higher than the upper surface of the tray 1, so that the tray 1 has a higher flange below an edge thereof, thereby raising a grip.

### Embodiment 3

As shown in FIG. 6, this embodiment also provides a flexible container having a structure similar to that of Embodiment 1, except that a top surface of a reinforcing ring 4 in this embodiment is higher than an upper surface of a tray 1. At the same time, a bottom surface of the reinforcing ring 4 is lower than the upper surface of the tray 1 and higher than a lower surface of the tray 1. This embodiment is also a particular way of arranging the reinforcing ring 4 in such a position that the reinforcing ring 4 is embedded in the peripheral flange so that a rigidity and a stability of the peripheral flange as a whole are enhanced, the tray 1 is provided with sufficient support to avoid shrinkage and sinking, and a bottom surface of the peripheral flange 3 is equal to or slightly lower than the lower surface of the tray 1, so that the peripheral flange 3 has a higher flange above an edge of the tray 1, and the reinforcing ring 4 can be applied to baking tray products to prevent liquid overflow.

Obviously, the above-mentioned embodiments of the invention are merely examples for clearly illustrating the invention, and are not intended to limit the embodiments of the invention. Other variations or variations may be made to those of ordinary skill in the art based on the foregoing description. All embodiments need not be, and cannot be, exhaustive. Any modifications, equivalent substitutions and improvements made within the spirit and principles of the invention are intended to be included within the scope of protection of the invention as claimed.

What is claimed is:

1. A flexible container, comprising a tray made of flexible material, wherein the tray is integrally formed with at least one placement cavity having an opening at a top portion thereof, a peripheral flange extends outward from a peripheral edge of the tray, the peripheral flange continuously surrounds the peripheral edge of the tray, the peripheral flange is embedded with a reinforcing ring, and a cross-section of the reinforcing ring has a longitudinal length greater than a lateral length.

2. The flexible container according to claim 1, wherein the reinforcing ring has a rectangular cross-section.

3. The flexible container according to claim 1, wherein horizontal projections of side surfaces of the reinforcing ring and side surfaces between upper and lower surfaces of the tray at least partially overlap.

4. The flexible container according to claim 3, wherein a top surface of the reinforcing ring is higher than the upper surface of the tray, and a bottom surface of the reinforcing ring is lower than the lower surface of the tray.

5. The flexible container according to claim 4, wherein a distance between the top surface of the reinforcing ring and the upper surface of the tray is equal to a distance between the bottom surface of the reinforcing ring and the lower surface of the tray.

6. The flexible container according to claim 3, wherein a top surface of the reinforcing ring is lower than the upper surface of the tray and higher than the lower surface of the tray; a bottom surface of the reinforcing ring is lower than the lower surface of the tray.

7. The flexible container according to claim 3, wherein a top surface of the reinforcing ring is higher than the upper surface of the tray; a bottom surface of the reinforcing ring is lower than the upper surface of the tray and higher than the lower surface of the plane of the tray.

8. The flexible container according to claim 3, wherein a bottom surface of the peripheral flange is lower than the lower surface of the tray, and the peripheral flange is spaced a distance from the placement cavity so that the tray is formed with a gripping surface portion between the peripheral flange and the placement cavity.

9. The flexible container according to claim 8, wherein a number of the placement cavity is even, each placement cavity is distributed in an array, the tray is in a rectangular structure, and a width of the gripping surface portion of one of opposite sides of the tray is smaller than a width of the gripping surface portion of the other one of the opposite sides.

10. The flexible container according to claim 1, wherein a protruding rib extends upwardly from an edge of the opening of the placement cavity of the tray, and the protruding rib continuously surrounds the opening of the placement cavity and is integrally formed with the tray.

11. The flexible container according to claim 10, wherein a protrusion height of the peripheral flange is greater than a protrusion height of the protruding rib.

12. The flexible container according to claim 1, wherein the tray is formed by injection molding.
